(19) United States
(12) Patent Application Publication
(10) Pub. No.: US 2024/0010029 A1
(43) Pub. Date: Jan. 11, 2024

(54) SPUR TOOTHING SYSTEM FOR WHEEL BEARING ARRANGEMENT

(71) Applicant: Schaeffler Technologies AG & Co. KG, Herzogenaurach (DE)

(72) Inventors: Andreas Kaiser, Werneck (DE); Simon Braehler, Petersberg (DE); Daniel Koenig, Grafenrheinfeld (DE); Norbert Gross, Werneck (DE)

(73) Assignee: Schaeffler Technologies AG & Co. KG, Herzogenaurach (DE)

(21) Appl. No.: 18/267,154

(22) PCT Filed: Aug. 20, 2021
(86) PCT No.: PCT/DE2021/100705

§ 371 Date: Jun. 14, 2023

(30) Foreign Application Priority Data
Dec. 16, 2020 (DE) 10 2020 133 758.2

(51) Int. Cl. B60B 27/00; F16D 1/10

(52) U.S. Cl. CPC B60B 27/0031; F16D 1/101

(57) ABSTRACT

A spur toothing system for a wheel bearing arrangement includes a plurality of radially extending teeth configured to axially engage mating teeth of a counter-toothing system. Each one of the radially extending teeth includes a tooth base plane, a pair of tooth flanks and a tooth tip. The tooth base is plane defined at a radial height where a width of the one of the radially extending teeth is equal to a gap between the one of the radially extending teeth and an adjacent one of the radially extending teeth. The pair of tooth flanks has a common tooth flank height measured radially from the tooth base plane and the tooth tip has a tooth tip height measured radially from the tooth base plane. The tooth tip merges tangentially into each of the pair of tooth flanks and is formed from at least two tangential radii.

### CROSS-REFERENCE TO RELATED APPLICATIONS

This application is the United States National Phase of PCT Appln. No. PCT/DE2021/100705 filed Aug. 20, 2021, which claims priority to German Application No. DE102020133758.2 filed Dec. 16, 2020, the entire disclosures of which are incorporated by reference herein.

### TECHNICAL FIELD

The present disclosure relates to a spur toothing system for a wheel bearing arrangement, in particular a Hirth toothing system for driven wheel bearings.

### BACKGROUND

The use of spur toothing systems as an axially effective coupling of rotating elements, such as shafts, is well known. For example, EP 2 363 301 A1 discloses a spur toothing system of a sprocket extending in the circumferential direction about an axis of rotation on a wheel bearing arrangement for a drivable wheel hub, wherein the spur toothing system is provided for backlash-free engagement in a counter-toothing system facing the spur toothing system.

Among other things, spur toothing systems can be produced by machining or by a forming process. The assembly of spur toothing systems, in particular the engagement of two spur toothing systems with one another, can be made more difficult by the known manufacturing processes.

### SUMMARY

The present disclosure provides an improved spur toothing system for a wheel bearing arrangement that simplifies assembly, and in particular avoids a tooth-on-tooth positioning during assembly and allows for improved forming of the teeth.

The spur toothing system according to the present disclosure, e.g., a Hirth toothing system, for a wheel bearing arrangement, e.g., for driven wheel bearings, has a plurality of teeth which are arranged on the spur side and extend radially, i.e., in the radial direction. Furthermore, the teeth are configured to engage axially, i.e., in the axial direction, into teeth of a counter-toothing system. Here, two adjacent teeth of the spur toothing system form a tooth gap between them. Each of the teeth has lateral tooth flanks and, substantially centrally, for example, a tooth tip which have a predefined tooth flank height and a predefined tooth tip height in relation to a tooth base plane, wherein the tooth flanks and the tooth tip merge tangentially into one another. The tooth tip is formed from at least two radii, e.g., three radii, which are coupled substantially tangentially to one another.

Such a tooth tip shape makes it possible to reduce a flow resistance for the material during the creation of the toothing by a forming process and thus to simplify the forming of the tooth geometry, e.g., in the center of the tooth tip. Furthermore, the tooth tip is prevented from rising on the lateral surfaces and creating a plateau or concave formation similar to a thread tap.

The tooth base plane is the plane on which the tooth widths and the tooth gaps in between are of equal width. The end face on which the spur toothing system is arranged can be designed to be substantially flat or slightly conical.

The spur toothing system is used, for example, for wheel bearing arrangements with driven wheel bearings, e.g., for coupling a wheel bearing to the drive shaft or the axle journal.

According to one embodiment, the tooth tip is formed from two flank radii and a tip radius, and the two flank radii and the tip radius are each smaller than a single tangential connecting radius which is configured to form the tooth tip and laterally merges tangentially into the tooth flanks. In this regard, the tip radius is arranged substantially centered between the two flank radii and one flank radius each merges tangentially into the tooth flanks.

The single tangential connecting radius is a single radius that merges tangentially into the tooth flanks on both sides and forms the tooth tip. Therefore, the connecting radius can also be referred to as a single tangential tooth tip radius.

The two flank radii and the tip radius allow for a more flexible and versatile formation of the tooth tip. The radii can be arranged differently to one another, so that different tooth tip heights can result for a tooth flank height and/or different tooth tip heights can result for a tooth tip height, and the single tangential connecting radius always results in an exact pairing of a predefined tooth flank height and a predefined tooth tip height. Thus, the geometry of the teeth of the spur toothing system can be adapted depending on the planned application. The flank radii may be identical to one another in order to obtain a symmetrical cross-sectional profile of a tooth of the spur toothing system.

According to one embodiment, the flank radii and the tip radius are connected substantially tangentially to one another via connecting geometries. In addition, the flank radii merge substantially tangentially into the tooth flanks. Both the flank radii and the tip radius are smaller than the single tangential connecting radius. In particular, the flank radii can coincide with the tip radius. Alternatively, the flank radii can be different from the tip radius. Depending on whether the tooth tip is to be more pointed or flatter, the tip radius can be arranged offset to the top relative to the flank radii, closer to the tooth tip.

According to one embodiment, the connecting geometries are formed as connecting straight lines and/or connecting radii and/or a free-form connecting lines. According to one embodiment, the connecting straight lines are formed, for example, as connecting tangents which tangentially connect the flank radii and the tip radius to one another.

A substantially tangentially formed connection of the radii by the connecting geometries allows for a simple production of the spur toothing system, e.g., by means of a forming process. In addition, the spur toothing system with connecting geometries that connect the flank radii and the tip radius substantially tangentially to one another allows for a simplified assembly. Alternatively, the connecting geometries can connect the flank radii and the tip radius to one another in such a way that the transition forms an edge in each case. This means that the connecting geometries also connect the flank radii and the tip radius to one another non-tangentially.

According to a further embodiment, the tooth tip is formed from two flank radii and a tip radius. The two flank radii are each smaller than a single tangential connecting radius, and the tip radius is greater than the single tangential connecting radius. The single tangential connecting radius is configured to form a tooth tip and merges tangentially into the tooth flanks. This means that the single tangential connecting radius describes a continuous radius that merges tangentially into the tooth flanks on both sides. The tip radius may extend in such a way that it tangentially connects the two flank radii to one another.

The single tangential connecting radius is a single radius that merges tangentially into the tooth flanks on both sides and forms the tooth tip. Therefore, the connecting radius can also be referred to as a single tangential tooth tip radius.

The two flank radii and the tip radius allow for a more flexible and versatile formation of the tooth tip. The radii can be arranged differently to one another, so that different tooth tip heights can result for a tooth flank height and/or different tooth tip heights can result for a tooth tip height, and the single tangential connecting radius always results in an exact pairing of a predefined tooth flank height and a predefined tooth tip height. Thus, the geometry of the teeth of the spur toothing system can be adapted depending on the planned application. The flank radii may be identical to one another in order to obtain a symmetrical cross-sectional profile of a tooth of the spur toothing system.

According to one embodiment, the two flank radii and the tip radius merge substantially tangentially into one another. For example, the tip radius is designed so as to merge tangentially into the flank radii. In other words, the tip radius can be said to be designed as a curved connecting line that substantially tangentially connects the two flank radii to one another. Depending on the size of the tip radius, the tooth tip is flatter or more pointed.

A substantially tangentially formed connection of the flank radii by the tip radius allows for a simple production of the spur toothing system, e.g., by means of a forming process, and simplifies assembly. Alternatively, it is also possible for the tip radius to merge into the flank radii, forming an edge.

According to one embodiment, for a predefined, substantially equal, tooth flank height, the tooth tip height of the tooth with the tooth tip from the two flank radii and the tip radius is smaller than a tooth tip height of the tooth with the tooth tip from the single tangential connecting radius. Due to the lower tooth tip height, a lower degree of forming is required when the spur toothing system is produced by means of a forming process to produce the tooth shape, which reduces the flow resistance of the material required to form the tooth shape, and can improve the formation of the toothing.

According to one embodiment, for a predefined, substantially equal, tooth tip height, the tooth flank height of the tooth with the tooth tip from the two flank radii and the tip radius is greater than a tooth flank height of the tooth with the tooth tip from the single tangential connecting radius. The increased tooth flank height provides a larger contact area for axial engagement with a counter-toothing system, thus allowing for improved torque transmission. In addition, such a tooth shape improves the ease of assembly. Both a more pointed tip design and a flatter tip design can be implemented.

According to one embodiment, the tooth tip height from the two flank radii and the tip radius is smaller than the tooth tip height from the single tangential connecting radius, if the tooth flank height of the tooth with the tooth tip from the two flank radii and the tip radius is smaller or greater than the tooth flank height of the tooth with the tooth tip from the single tangential connecting radius.

The lower tooth tip height allows for the tooth tip to be formed more bluntly or flatter, which means that the degree of forming required to produce the tooth shape is lower when the spur toothing system is produced by means of a forming process. This reduces the process force or forming force required to form the tooth and thus simplifies the formation of the tooth. In addition, the tooth flank height can be selected independently of the tooth tip height. This allows the tooth flank height to be individually adapted to the torque to be transmitted by the spur toothing system during operation.

In other words, it can be said that the formation of the tooth tip from several radii makes it possible to select the tooth tip height substantially independently of the tooth flank height. This makes it possible to improve the adaptation of the spur toothing system to the respective operating conditions and/or to simplify assembly.

### BRIEF DESCRIPTION OF THE DRAWINGS

The present disclosure is described in more detail below together with the description of an exemplary embodiment based on the figures. In the figures:

FIG. 1 shows a schematic representation of a spur toothing system,

FIG. 2 shows a schematic representation of a tooth tip shape of a tooth of the spur toothing system according to one embodiment;

FIG. 3 shows a schematic representation of a further tooth tip shape of a tooth of the spur toothing system according to one embodiment;

FIG. 4 shows a schematic representation of a further tooth tip shape of a tooth of the spur toothing system according to one embodiment; and

FIG. 5 shows a schematic representation of a further tooth tip shape of a tooth of the spur toothing system according to one embodiment.

### DETAILED DESCRIPTION

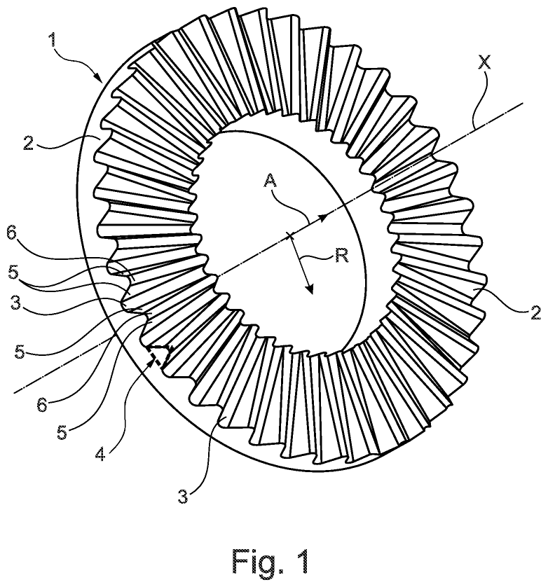

FIG. 1 shows an exemplary schematic representation of a spur toothing system 1 in a perspective view. The spur toothing system 1 has a plurality of teeth 2, which are separated in the circumferential direction by tooth gaps 3 and are arranged on a surface, for example an end face of a shaft. A tooth profile 4 of the teeth 2 is formed in the axial direction A, in this case the direction of the axis of rotation X. The direction of extension of the teeth 2 corresponds to the radial direction R.

Each of the teeth 2 has tooth flanks 5 and a tooth tip 6. The tooth flanks 5 are formed on lateral surfaces of the tooth 2 and merge tangentially into the tooth tip 6, which forms the “tip” of the tooth 2 substantially centrally and comprises the highest point of a tooth 2 as viewed in the axial direction A.

The spur toothing system 1 can also be referred to as a Hirth toothing system and is an axially effective toothing that can be used as a form-fitting coupling of rotating elements, for example to couple driven wheel bearings to the drive shaft, for torque transmission. For this purpose, the spur toothing system 1 engages in the axial direction A in a correspondingly designed counter-toothing system (not shown). In such a connection, the teeth 2 lie statically and flat against the teeth of the counter-toothing system.

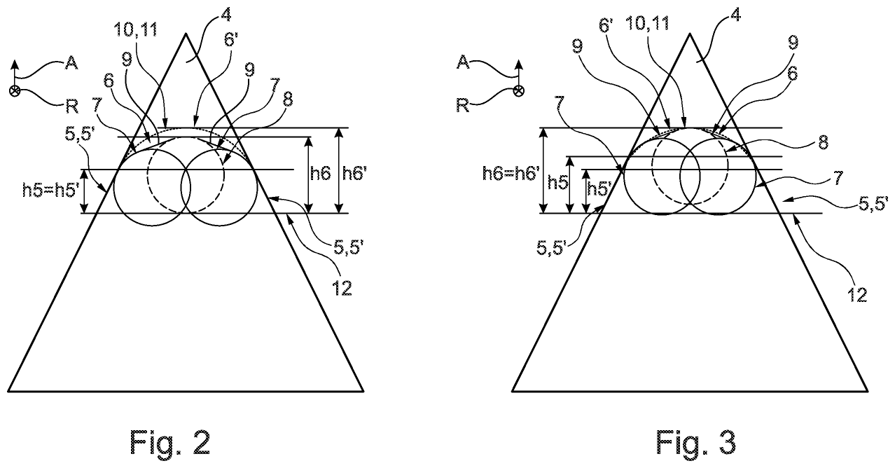

FIGS. 2 to 5 show schematic representations of a tooth profile 4 of a tooth 2 of the spur toothing system 1 for forming the tooth flanks 5 and the tooth tip 6 according to various embodiments of the present disclosure. Here, the tooth tip 6 is formed by several radii, each of which is tangentially connected to the other and merges tangentially into the tooth flanks 5.

FIG. 2 shows a front view of the tooth profile 4 to illustrate a possible tooth tip shape according to one embodiment of the present disclosure, in which the tooth tip 6 is formed by a total of three radii, two flank radii 7 and a tip radius 8. In FIG. 2, the two flank radii 7 and the tip radius 8 are equal in size, and the two flank radii 7 are arranged so as to merge tangentially into the tooth flanks 5 on the sides of the tooth profile 4. The tip radius 8 is arranged higher than the flank radii 7 when viewed in the axial direction A, and the flank radii 7 and the tip radius 8 are tangentially connected via connecting tangents 9 to form the tooth tip 6.

In addition, FIG. 2 shows a single tangential connecting radius 10, which merges tangentially into tooth flanks 5′ on both sides. The single tangential connecting radius describes the possibility of forming the shape of a tooth tip 6′ with only one radius. Therefore, the single tangential connecting radius can also be referred to as a single tangential tooth tip radius 11. Both the flank radii 7 and the tip radius 8 are smaller than the single tangential connecting radius 10.

It can be seen that a tooth tip height h6 of the tooth tip 6 formed by the two flank radii 7 and the tip radius 8 tangentially connected to one another by the connecting tangents 9 is smaller than a tooth tip height h6′ of the tooth tip 6′ formed by the single tangential connecting radius 10, if a tooth flank height h5 of the tooth 2 with the tooth tip 6 is equal to a tooth flank height h5′ of a tooth 2 with the tooth tip 6′. The tooth flank height h5, h5′ and the tooth tip height h6, h6′ are measured in relation to a tooth base plane 12. The tooth base plane 12 corresponds to the plane in which the tooth 2 and an adjacent tooth gap 3 are of equal width.

Due to the lower tooth tip height h6, the degree of forming required to produce the shape of the tooth tip 6 is lower than that required to produce the shape of the tooth tip 6′. In addition, the tooth tip 6 is more pointed than the tooth tip 6′, which improves the ease of assembly. The term “ease of assembly” refers to the assembly, i.e., the joining, of the spur toothing system 1 with a correspondingly designed counter-toothing system. A more pointed shape of the tooth tip 6 reduces the risk of a tooth-on-tooth positioning during assembly of the spur toothing system 1 with the correspondingly designed counter-toothing system.

FIG. 3 shows a front view of the tooth profile 4 to illustrate a possible tooth tip shape according to one embodiment, in which the tooth tip 6 is formed from the two flank radii 7 and the tip radius 8, as in FIG. 2. The embodiment shown in FIG. 3 is similar to the embodiment shown in FIG. 2, so only the differences will be discussed below.

In FIG. 3, the tooth tip height h6 of tooth 2 with the tooth tip 6 is equal to the tooth tip height h6′ of the tooth 2 with the tooth tip 6′. It can be seen that for the same tooth tip height, the tooth flank height h5 of the tooth flank 5 of the tooth 2 with the tooth tip 6 is greater than the tooth flank height h5′ of a tooth flank 5′ of the tooth 2 with the tooth tip 6′. The increased tooth flank height h5 provides a larger contact area for torque transmission when engaging with a correspondingly designed counter-toothing system. This enables improved torque transmission during operation. In addition, the tooth tip 6 is more pointed than the tooth tip 6′, which improves the ease of assembly.

In FIGS. 2 and 3, the flank radii 7 are equal in size to the tip radius 8. However, it is also conceivable that the flank radii 7 and the tip radius 8 are different, and both the flank radii 7 and the tip radius 8 are smaller than the single tangential connecting radius 10. The two flank radii 7 may be equal in size to obtain a substantially symmetrical tooth profile 4.

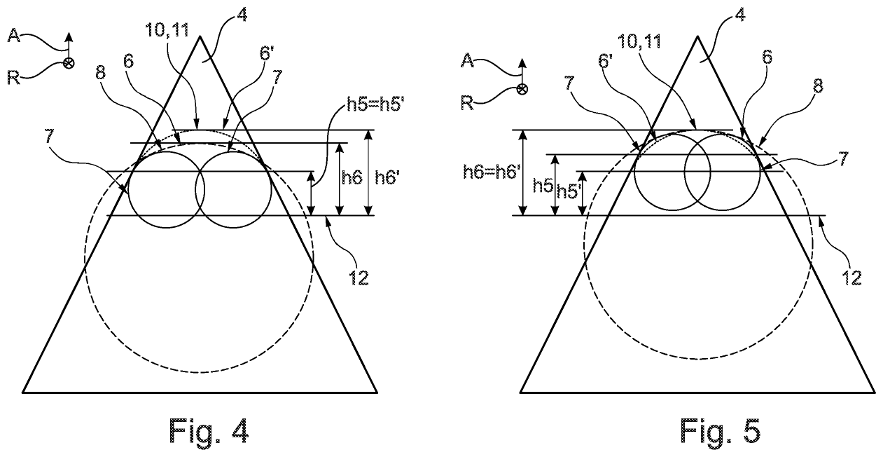

FIG. 4 shows a front view of the tooth profile 4 to illustrate a possible tooth tip shape according to one embodiment, in which the tooth tip 6 is formed by a total of three radii, two flank radii 7 and a tip radius 8. In FIG. 4, the two flank radii 7 are equal in size, wherein the two flank radii 7 are arranged so as to merge tangentially into the tooth flanks 5 on the sides of the tooth profile 4. The tip radius 8 is greater than the flank radii 7 and, viewed in the axial direction A, is arranged in such a way that the tip radius 8 merges tangentially into the flank radii 7 to form the tooth tip 6.

In addition, FIG. 4 shows the single tangential connecting radius 10, which merges tangentially into the tooth flanks 5′ on both sides. The flank radii 7 according to the embodiment shown in FIG. 4 are smaller than the single tangential connecting radius 10, while the tip radius 8 is greater than the single tangential connecting radius 10.

It can be seen that the tooth tip height h6 of the tooth tip 6 formed by the two flank radii 7 and the tip radius 8 merging tangentially into one another is smaller than a tooth tip height h6′ of the tooth tip 6′ formed by the single tangential connecting radius 10, if the tooth flank height h5 of the tooth 2 with the tooth tip 6 is equal to the tooth flank height h5′ of a tooth 2 with the tooth tip 6′.

Due to the lower tooth tip height h6, the degree of forming required to produce the shape of the tooth tip 6 is lower than that required to produce the shape of the tooth tip 6′. In addition, the lower tooth tip height h6 improves the ease of assembly because the lower degree of forming significantly reduces or even completely prevents a plateau formation on the tooth tip 6. This reduces the risk of a tooth-on-tooth positioning during assembly of the spur toothing system 1 with the correspondingly designed counter-toothing system.

FIG. 5 shows a front view of the tooth profile 4 to illustrate a possible tooth tip shape according to one embodiment, in which the tooth tip 6 is formed from the two flank radii 7 and the tip radius 8, as in FIG. 4. The embodiment shown in FIG. 5 is similar to the embodiment shown in FIG. 4, so only the differences will be discussed below.

In FIG. 5, the tooth tip height h6 of tooth 2 with the tooth tip 6 is equal to the tooth tip height h6′ of the tooth 2 with the tooth tip 6′. It can be seen that for the same tooth tip height, the tooth flank height h5 of the tooth flank 5 of the tooth 2 with the tooth tip 6 is greater than the tooth flank height h5′ of a tooth flank 5′ of the tooth 2 with the tooth tip 6′. The increased tooth flank height h5 provides a larger contact area for torque transmission when engaging with a correspondingly designed counter-toothing system. This enables improved torque transmission during operation. In addition, the tooth tip 6 is formed flatter than the tooth tip 6′, reducing the degree of forming required to produce the shape of the tooth tip 6, which improves the ease of assembly and/or reduces the risk of a tooth-on-tooth positioning during assembly of the spur toothing system 1 with the correspondingly designed counter-toothing system.

From the synopsis of the figures, it can be seen that the formation of the tooth tip 6 by a plurality of radii is significantly more flexible with regard to the design of the tooth flank height and the tooth tip height and/or the tooth tip shape than the single tangential connecting radius. This allows for the spur toothing system 1, e.g., the teeth 2, to be adapted to the respective requirements of the intended application.

### REFERENCE NUMERALS

1 Spur toothing system
2 Tooth
3 Tooth gap
4 Tooth profile
5, 5′ Tooth flank
6, 6′ Tooth tip
7 Flank radius
8 Tip radius
9 Connecting tangent
10 Single tangential connecting radius
11 Single tangential tooth tip radius
12 Tooth base plane
A Axial direction
R Radial direction
X Axis of rotation
h5, h5′ Tooth flank height
h6, h6′ Tooth tip height

1. A spur toothing system for a wheel bearing arrangement, having:
a plurality of teeth which are arranged on the spur side, extend radially, and are configured to engage axially into teeth of a counter-toothing system,
wherein each of the teeth has tooth flanks and a tooth tip which have a predefined tooth flank height (h5) and a predefined tooth tip height (h6) in relation to a tooth base plane, wherein the tooth flanks and the tooth tip merge tangentially into one another, and
wherein the tooth tip is formed from at least two radii which are coupled substantially tangentially to one another.

2. The spur toothing system according to claim 1, wherein the tooth tip is formed from two flank radii and a tip radius, wherein the two flank radii and the tip radius are each smaller than a single tangential connecting radius which is configured to form the tooth tip and laterally merges substantially tangentially into the tooth flanks.

3. The spur toothing system according to claim 2, wherein the flank radii and the tip radius are coupled substantially tangentially to one another via connecting geometries.

4. The spur toothing system according to claim 3, wherein the connecting geometries are formed as connecting straight lines or connecting radii or free-form connecting lines.

5. The spur toothing system according to claim 4, wherein the connecting straight lines are formed as connecting tangents which tangentially connect the flank radii and the tip radius to one another.

6. The spur toothing system according to claim 1, wherein the tooth tip is formed from two flank radii and a tip radius, wherein the two flank radii are each smaller than a single tangential connecting radius which is configured to form the tooth tip and laterally merges tangentially into the tooth flanks, and wherein the tip radius is greater than the single tangential connecting radius.

7. The spur toothing system according to claim 6, wherein the two flank radii and the tip radius merge tangentially into one another.

8. The spur toothing system according to claim 2, wherein at a predefined equal tooth flank height (h5, h5′), the tooth tip height (h6) of the tooth with the tooth tip from the two flank radii and the tip radius is smaller than a tooth tip height (h6′) of the tooth with the tooth tip from the single tangential connecting radius.

9. The spur toothing system according to claim 2, wherein at a predefined equal tooth tip height (h6, h6′), the tooth flank height (h5) of the tooth with the tooth tip from the two flank radii and the tip radius is greater than a tooth flank height (h5′) of the tooth with the tooth tip from the single tangential connecting radius.

10. The spur toothing system according to claim 2, wherein the tooth tip height (h6) of the tooth with the tooth tip from the two flank radii and the tip radius is smaller than the tooth tip height (h6′) of the tooth with the tooth tip from the single tangential connecting radius, if the tooth flank height (h5) of the tooth with the tooth tip from the two flank radii and the tip radius is smaller or greater than the tooth flank height (h5′) of the tooth with the tooth tip from the single tangential connecting radius.

11. A spur toothing system for a wheel bearing arrangement, comprising a plurality of radially extending teeth configured to axially engage mating teeth of a counter-toothing system, each one of the plurality of radially extending teeth comprising:
a tooth base plane defined at a radial height where a width of the one of the plurality of radially extending teeth is equal to a gap between the one of the plurality of radially extending teeth and an adjacent one of the plurality of radially extending teeth;
a pair of tooth flanks comprising a common tooth flank height measured radially from the tooth base plane; and
a tooth tip comprising a tooth tip height measured radially from the tooth base plane, the tooth tip merging tangentially into each of the pair of tooth flanks and formed from at least two tangential radii.

12. The spur toothing system of claim 11, wherein:
the tooth tip is formed from two flank radii and a tip radius; and
the two flank radii and the tip radius are each smaller than a single tangential connecting radius configured to form the tooth tip and tangent to each of the pair of tooth flanks.

13. The spur toothing system of claim 12, wherein the tooth tip further comprises connecting geometries extending tangentially from the tip radius to each of the two flank radii.

14. The spur toothing system of claim 13, wherein the connecting geometries are formed as:
connecting straight lines;
connecting radii; or
free-form connecting lines.

15. The spur toothing system of claim 12, wherein:
the common tooth flank height is equal to a single tangential connecting radius tooth flank height measured radially from the tooth base plane; and
the tooth tip height is less than a single tangential connecting radius tooth tip height measured radially from the tooth base plane.

16. The spur toothing system of claim 12, wherein:
the common tooth flank height is equal to a single tangential connecting radius tooth flank height measured radially from the tooth base plane; and
the tooth tip height is greater than a single tangential connecting radius tooth tip height measured radially from the tooth base plane.

17. The spur toothing system of claim 11, wherein:
the tooth tip is formed from two flank radii and a tip radius;
the two flank radii are each smaller than a single tangential connecting radius configured to form the tooth tip and tangent to each of the pair of tooth flanks; and
the tip radius is greater than the single tangential connecting radius.

18. The spur toothing system of claim 17, wherein the tip radius is tangent to each of the two flank radii.

19. The spur toothing system of claim 17, wherein:
the common tooth flank height is equal to a single tangential connecting radius tooth flank height measured radially from the tooth base plane; and
the tooth tip height is less than a single tangential connecting radius tooth tip height measured radially from the tooth base plane.

20. The spur toothing system of claim 17, wherein:
the common tooth flank height is equal to a single tangential connecting radius tooth flank height measured radially from the tooth base plane; and
the tooth tip height is greater than a single tangential connecting radius tooth tip height measured radially from the tooth base plane.
